(19) United States
(12) Patent Application Publication
(10) Pub. No.: US 2014/0227589 A1
(43) Pub. Date: Aug. 14, 2014

(54) POLYMER AND SECONDARY BATTERY USING SAME

(71) Applicant: HITACHI MAXELL, LTD., Ibaraki-shi, Osaka (JP)

(72) Inventors: Kenji Kono, Ibaraki-shi (JP); Naoki Usuki, Mishima-gun (JP); Hidetoshi Morikami, Hitachi-shi (JP); Hisao Kanzaki, Takatsuki-shi (JP); Fusaji Kita, Ibaraki-shi (JP)

(21) Appl. No.: 14/342,047

(22) PCT Filed: Nov. 28, 2012
(86) PCT No.: PCT/JP2012/080741

§ 371 Date: Feb. 28, 2014

(30) Foreign Application Priority Data
Dec. 5, 2011 (JP) 2011-265379

(51) Int. Cl. H01M 10/0565; H01M 10/05

(52) U.S. Cl. CPC H01M 10/0565; H01M 10/05
USPC 429/188; 525/56; 429/122

(57) ABSTRACT

A polymer of the present invention has a plurality of pendant groups. Each of the pendant groups is constituted of a carboxyl group or a salt thereof, and a group interposed between a main chain and either the carboxyl group or salt thereof. The group interposed between the main chain and either the carboxyl group or salt thereof is: a hydrocarbon group; a perfluorocarbon group; constituted of a hydrocarbon group and at least one of an ester group and a carbonate group; or constituted of a perfluorocarbon group and at least one of an ester group and a carbonate group. A carbonyl carbon included in the carboxyl group or salt thereof is bonded directly to a carbon included in either the hydrocarbon group or the perfluorocarbon group.

### TECHNICAL FIELD

The present invention relates to a polymer that is useful even in the presence of an organic solvent, and a secondary battery using the polymer.

### BACKGROUND ART

Since a polymer containing a salt of a carboxyl group typically exhibits a high ion dissociation and a strong hydrophilicity in water, it is applied widely in the field of absorbents, hydrogel and the like. However, since such a salt of carboxyl group has a low ion dissociation in an organic solvent, the metal ion will be constrained by the polymer. As a result, under an atmosphere where such an organic solvent exists for example, a normal polymer containing a salt of a carboxyl group cannot exhibit various functions based on its structure.

In the meantime, a copolymer composed of a polymerization unit based on polyvinylidene fluoride and a polymerization unit having a side chain containing —CF₂COOLi or —CF₂SO₃Li has a favorable retention and a high ionic conductivity in a case where an organic solvent is contained. Therefore, it has been tried to use the copolymer for the polymer electrolyte of a lithium battery (Patent document 1). The salt of carboxyl group in the side chain included in the copolymer as described in Patent document 1 is considered as having a high ion dissociation in an organic solvent, and thus on the basis of its characteristics, it is expected to constitute a polymer electrolyte of a high ionic conductivity.

### PRIOR ART DOCUMENTS

### Patent Documents

Patent document 1: JP H10-284128

### DISCLOSURE OF INVENTION

### Problem to be Solved by the Invention

The copolymer described in Patent document 1 has the above-described advantages, but it has a poor resistance to oxidation (resistance to oxidation-decomposition), whereby the fields of its application may be limited. For example, regarding a currently-used non-aqueous secondary battery (lithium ion secondary battery), there has been a study of using the battery after charging at a higher final voltage because of necessity of higher capacity. However, as a result, the various materials used in the battery will be kept under an atmosphere that accelerates oxidation. Therefore, in a case where the copolymer described in Patent document 1 is applied to this battery, there is apprehension of loss of functions due to oxidation-decomposition and degradation in the battery characteristics caused by inhibition of the battery reaction by the decomposition product.

Under this situation, in order to expand the range of application of the polymer containing a carboxyl group and salt thereof, the polymer is required to exhibit favorably the functions based on its structure even in the presence of an organic solvent. In addition to that, the polymer is required to ensure oxidation resistance so as to sufficiently suppress decomposition even under an atmosphere that accelerates oxidation.

In light of the above-described circumstances, the present invention aims to provide a polymer that is excellent in oxidation resistance and that is capable of exhibiting its function provided by a carboxyl group or salt thereof even in the presence of an organic solvent, and a secondary battery using the polymer.

### Means for Solving Problem

A polymer of the present invention is a polymer having a plurality of pendant groups, wherein each of the pendant groups is constituted of a carboxyl group or a salt of the carboxyl group, and a group interposed between a main chain and the carboxyl group or salt thereof. The group interposed between the main chain and the carboxyl group or salt thereof is; a hydrocarbon group; a perfluorocarbon group; constituted of a hydrocarbon group and at least one of an ester group and a carbonate group; or constituted of a perfluorocarbon group and at least one of an ester group and a carbonate group. A carbonyl carbon included in the carboxyl group or salt thereof is bonded directly to a carbon included in either the hydrocarbon group or the perfluorocarbon group. In a case where the group interposed between the main chain and the carboxyl group or salt thereof is the hydrocarbon group or constituted of the hydrocarbon group and the at least one of the ester group and the carbonate group, fluorine is bonded to at least a carbon among the carbons included in the hydrocarbon group located at an α-position or a β-position of the carbonyl carbon included in the carboxyl group or salt thereof.

A secondary battery of the present invention is a secondary battery comprising a positive electrode containing a positive electrode active material, a negative electrode, a separator and an electrolyte, and the secondary battery contains the polymer according to the present invention as described above.

### Effects of the Invention

According to the present invention, it is possible to provide a polymer that is excellent in oxidation resistance and that can exhibit favorably its functions provided by a carboxyl group or salt thereof even in the presence of an organic solvent, and a secondary battery using the polymer.

### BRIEF DESCRIPTION OF DRAWINGS

FIG. 1 is a graph showing an evaluation result of charge-discharge cycle characteristics of non-aqueous secondary batteries according to Example 1 and Comparative example 1.

### DESCRIPTION OF THE INVENTION

<Polymer>

The polymer of the present invention has a structure including a plurality of pendant groups bonded to a main chain, and each of the pendant groups is constituted of a carboxyl group or salt thereof, and a group interposed between a main chain and the carboxyl group or salt thereof.

Examples of the salt of the carboxyl group of the pendant groups include: a metal salt of a carboxyl group, an ammonium salt of a carboxyl group, and the like. The metal salt of a carboxyl group may be an alkali metal salt (monovalent metal salt) such as lithium salt, sodium salt, potassium salt and the like; or a divalent or higher metal salt such as alkaline earth metal salt like magnesium salt, calcium salt, strontium salt and barium salt. In a case where the salt of the carboxyl group of the pendant group is a divalent or higher metal salt, a ring structure including the plural pendant groups may be formed within the molecule of the polymer, or a crosslinked structure by the plural pendant groups may be formed among the molecules of the polymer.

The group interposed between the main chain and the carboxyl group or salt thereof in the pendant group is constituted of a hydrocarbon group (hydrocarbon chain); a perfluorocarbon group (a group obtained by substituting all of hydrogen of a hydrocarbon group with fluorine); a hydrocarbon group (hydrocarbon chain) and at least one of an ester group (ester bond) and a carbonate group (carbonate bond); or a perfluorocarbon group and at least one of an ester group and a carbonate group. Since these groups are more resistant to oxidation-decomposition in comparison with an ether group (ether bond) or the like, the oxidation resistance of the polymer becomes favorable.

In a more specific structure for a case where the group interposed between the main chain and the carboxyl group or salt thereof in the pendant group includes a hydrocarbon group and at least one of the ester group and the carbonate group, for example, the carboxyl group or salt thereof is bonded to the hydrocarbon group and this hydrocarbon group is bonded to the main chain via either the ester group or the carbonate group. In a more specific structure for a case where the group interposed between the main chain and the carboxyl group or salt thereof in the pendant group includes a perfluorocarbon group and at least one of the ester group and the carbonate group, for example, the carboxyl group or salt thereof is bonded to the perfluorocarbon group and this perfluorocarbon group is bonded to the main chain via either the ester group or the carbonate group.

An example of the hydrocarbon group interposed between the main chain and the carboxyl group or salt thereof in the pendant group is a linear or branched alkylene group (alkylene chain). As described below, it is required that in the hydrocarbon group (for example, the linear or branched alkylene group), at least a part of the hydrogen be substituted by fluorine. It is preferable that the carbon number in the hydrocarbon group is in the range of 1 to 20, for example.

Further, the carbonyl carbon included in the carboxyl group or salt thereof in the pendant group is bonded directly to the carbon included in either the hydrocarbon group or the perfluorocarbon group in the pendant group. In a case where the group interposed between the main chain and the carboxyl group or salt thereof is a hydrocarbon group or is constituted of a hydrocarbon group and at least one of an ester group and a carbonate group, fluorine is bonded to at least a carbon among the carbons included in the hydrocarbon group, located at least at an α-position or a β-position of a carbonyl carbon included in the carboxyl group or salt thereof. Namely, with regard to a carbon located at either an α-position or a β-position of a carbonyl carbon, at least a part of hydrogen bondable thereto has been substituted by fluorine.

Further, in a case where the group interposed between the main chain and the carboxyl group or salt thereof is a perfluorocarbon group or constituted of a perfluorocarbon group and at least one of an ester group and a carbonate group, as described above, since the carbonyl carbon included in the carboxyl group or salt thereof is bonded directly to the carbon included in the perfluorocarbon group, it is considered that fluorine is bonded to at least a carbon located at the α-position of the carbonyl carbon included in the carboxyl group or salt thereof.

In the pendant group, since fluorine having a strong electron-withdrawing property is bonded to a carbon at the α-position or the β-position of the carbonyl carbon in the carboxyl group or salt thereof, the electron density on oxygen included in the carboxyl group or the salt is lowered, and as a result, hydrogen (in a case of a carboxyl group) or a counter ion (in a case of a salt of carboxyl group) is dissociated easily. Therefore, the polymer of the present invention exhibits favorable ion dissociation even in an organic solvent.

It is preferable that the pendant group includes a structural portion expressed by General Formula (1) below.

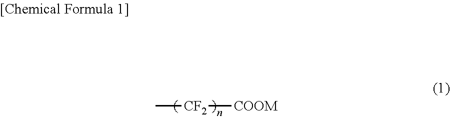

In the General Formula (1), n is an integer in the range of 1 to 20, and M denotes hydrogen, a metal or ammonium. Examples of M as a metal include, as described above, an alkali metal (monovalent metal) such as lithium, sodium, potassium and the like; and a divalent or higher metal such as an alkaline earth metal like magnesium, calcium, strontium, barium and the like.

In a case where the pendant group includes the structural portion as expressed by General Formula (1) above, the pendant group may be constituted of only the structural portion expressed by General Formula (1). Alternatively, it may be constituted by the structural portion expressed by General Formula (1) and an ester group or a carbonate group; or it may be constituted by bonding the structural portion expressed by General Formula (1) to either a hydrocarbon group or a perfluorocarbon group via an ester group or a carbonate group.

One pendant group may contain a plurality of the structural portion expressed by General Formula (1). Specifically, for example, the pendant group may have a hydrocarbon group (e.g., an alkylene group) other than the structural portion expressed by the General Formula (1) above, and a plurality of the structural portion expressed by the General Formula (1) may be bonded to the hydrocarbon group so as to constitute the pendant group.

The polymer of the present invention may contain only a pendant group having a carboxyl group. Alternatively, it may contain only a pendant group having a salt of carboxyl group; or it may contain both a pendant group having a carboxyl group and a pendant group having a salt of carboxyl group. In a case where one pendant group contains a plurality of carboxyl groups or salt thereof (e.g., in a case of including a plurality of the structural portions expressed by the General Formula (1) above), the pendant group may contain only carboxyl group, only salts of carboxyl group, or a carboxyl group and a salt of carboxyl group.

From the viewpoint of enhancing the oxidation resistance of the polymer, it is preferable that the main chain of the polymer is constituted of only a hydrocarbon group, only a perfluorocarbon group, a hydrocarbon group and at least one of an ester group and a carbonate group, or a perfluorocarbon group and at least one of an ester group and a carbonate group. A preferred example of the hydrocarbon group constituting the main chain is a linear or branched alkylene group (a part of hydrogen included in the alkylene group may be fluorine-substituted). A preferred example of the perfluorocarbon group constituting the main chain is a linear or branched perfluoroalkylene group (a group where all of the hydrogen included in an alkylene group is substituted by fluorine except for the part that has been substituted by the pendant group). From the viewpoint of reducing the cost for the polymer or from the viewpoint of enhancing performance requested for a particular use (e.g., adsorptivity to a positive electrode active material in a secondary battery as described below), a hydrocarbon group not substituted by fluorine (in particular, linear or branched alkylene group) is preferred further.

For providing various properties to the polymer, it is also possible to allow the polymer to contain any group(s) other than the pendant group. For example, the polymer may contain a group capable of improving a solubility to a solvent, a compatibility with other polymers, an adsorptivity to other material(s) or the like, a decomposition resistance in an electrolyte (e.g., an electrolyte used for a secondary battery), a gassing property and the like.

The polymer of the present invention has not only an excellent oxidation resistance but an excellent ion dissociation in an organic solvent. Utilizing these properties, the polymer can be applied favorably to electrochemical devices such as a member (an electrolyte additive, etc.) for an electric double layer capacitor or a secondary battery like a non-aqueous electrolyte battery, a material of a solid electrolyte for an all-solid battery using such a solid electrolyte, and a member of a dye sensitized solar cell.

The polymer of the present invention possesses both a hydrophilic moiety and a hydrophobic moiety, and a charge repulsion can be expected. Therefore, the polymer can be applied also to a dispersant, a solubilizer, a surface conditioner or the like. In addition to that, since the polymer can function as a gel material due to a chemical crosslink or a physical crosslink, the polymer can be applied to a hydrogel-replacing material, an oiling agent or the like using an organic solvent (e.g., a low-volatile organic solvent) in place of water. As the polymer of the present invention has an excellent oxidation resistance, even when it is applied to use other than such electrochemical devices, similarly high durability can be expected.

There is no particular limitation on the molecular weight of the polymer of the present invention as long as the molecular weight is suitable for the use of the polymer.

For example, when the polymer of the present invention is applied to an electrolyte (non-aqueous electrolyte) of an electrochemical device, the polymer experiences an ion dissociation in the electrolyte solvent (organic solvent), whereby it can function as an electrolyte salt to enhance the ionic conductivity of the electrolyte. In this case, since the ionic mobility is concerned in the ionic conductivity, it is preferable that the molecular weight of the polymer is not too high. Specifically, it is preferable that the number average molecular weight of the polymer is 500 or more, preferably, it is 2,000,000 or less, more preferably 1,000,000 or less, and further preferably 500,000 or less. Meanwhile, in a case of positioning the polymer at a site to be in contact with the positive electrode active material so as not to be contained in the electrolyte solvent, rather a higher molecular weight is preferred for the polymer.

Specifically, it is preferable that the number average molecular weight of the polymer is 500 or more, and 5,000,000 or less. More preferably it is 10,000 or more, and further preferably 30,000 or more.

In the present specification, the number average molecular weight of the polymer is a number average molecular weight (polystyrene equivalent) measured by using gel permeation chromatography.

It is preferable that the amount of the pendant group to be introduced into the polymer of the present invention is 5 mol % or more with respect to the monomer that constitutes the main chain; more preferably 10 mol % or more, and further preferably 30 mol % or more. There is no particular upper limit on the amount of the pendant group to be introduced into the polymer, and it may be selected in accordance with the solubility to the solvent in use, conditions depending on factors such as the facility in synthesis and steric hindrance, the cost and the like. If one pendant group can be introduced into one normal monomer, the upper limit of the pendant group with respect to the monomer constituting the main chain is 100 mol %. However, depending on the molecular structure of the monomer, a plurality of the pendant groups can be introduced into one monomer. In such a case, the upper limit on the amount of the pendant group with respect to the monomer constituting the main chain is 100 mol % or more.

In the present specification, the amount of the pendant group to be introduced into the polymer is a molar ratio of the pendant group to the monomer that constitutes the main chain, and it is calculated from the ratios of proton and respective elements obtained from a fluorine 19 nuclear magnetic resonance (NMR) measurement.

There is no particular limitation on the method for producing the polymer of the present invention, and any method may be employed. Examples of typical production method include: a method of allowing fluorinated dicarboxylic acid anhydride to react with a hydroxyl group of polyvinyl alcohol; a method of ester interchange between an acetyl group of polyvinyl acetate and fluorinated dicarboxylic acid; and a method of allowing fluorinated dicarboxylic acid anhydride to react with an amino group of polyethylene imine. Further, the carboxyl group of the pendant group introduced into the main chain in this manner is allowed to react with a hydroxide including a metal or ammonium to provide a counter ion or a salt of a weak acid such as carbonate, thereby it is possible to obtain a polymer having a pendant group containing a salt of carboxyl group. It is also possible to prepare in advance a monomer having a pendant group that contains fluorinated carboxylic acid or the salt thereof and to polymerize the same, thereby producing the polymer of the present invention.

<Secondary Battery>

A secondary battery of the present invention has a positive electrode (positive electrode that contains a positive electrode active material), a negative electrode, a separator and an electrolyte, and further contains the polymer of the present invention.

The polymer of the present invention is applicable for example as an electrolyte additive, an additive for protection of the positive electrode active material and the like in the secondary battery. Therefore in the secondary battery it is preferable that the polymer is positioned at sites to be in contact with either the electrolyte or the positive electrode active material, or it is captured in the electrolyte.

As described above, since the polymer of the present invention has a high ion dissociation, it is positioned at a site to be in contact with the electrolyte of the secondary battery (an electrolytic solution such as alkali electrolytic solution or non-aqueous electrolytic solution [including a gel electrolyte that has been gelled by the act of a gelling agent]; a solid electrolyte containing an organic solvent) or captured in the electrolyte, so that it contributes to enhancement of the ionic conductivity of the electrolyte.

It is also possible to utilize the polymer of the present invention as a protective agent for the positive electrode active material in the secondary battery. For example, for a non-aqueous secondary battery that uses an electrolyte containing an electrolyte solvent such as ethylene carbonate and an additive such as vinylene carbonate, it is known that a solid electrolyte interface (SEI) acting as a protective coating is formed on the surface of the negative electrode due to the reductive decomposition of the additive, and thus it is possible to suppress decomposition reaction of the electrolyte composition caused by a contact between the negative electrode and the electrolyte. Since the polymer also is present on the surface of the positive electrode active material of the secondary battery, an effect of suppressing the contact between the electrolyte and the positive electrode active material of the secondary battery so as to suppress the decomposition reaction of the electrolyte composition can be expected similarly to the case of the SEI layer. Namely, it is assumed that, since the polymer has a high ion dissociation, even when the polymer is present on the positive electrode active material, it does not inhibit insertion and desorption of ions while not allowing transmission of electrons, and thus oxidation decomposition of the electrolyte composition can be suppressed.

Unlike the SEI layer on the negative electrode surface as described above, it is not required to form the polymer of the present invention by decomposing and polymerizing an additive within the battery. Therefore, in the secondary battery of the present invention, in a case of utilizing the polymer as a protective agent for the positive electrode active material, it is required only to allow the polymer to be present in advance on the surface of the positive electrode active material or to be captured in the electrolyte, so that it can get contact with the positive electrode active material surface within the battery. In a case where the secondary battery is formed by use of the electrolyte in which the polymer has been captured, the polymer is adsorbed on the surface of the positive electrode active material so as to function as a protective agent.

The secondary battery of the present invention may be provided in a form of an alkaline electrolytic solution secondary battery having an alkaline electrolytic solution, a non-aqueous secondary battery (lithium ion secondary battery) having a non-aqueous electrolytic solution, a solid secondary battery (polymer secondary battery) having a solid electrolyte and the like. Hereinafter, among the secondary batteries of the present invention, the constitution of a non-aqueous secondary battery that is particularly important will be described in detail.

The non-aqueous secondary battery may be in the form of a cylindrical (circular or rectangular cylindrical) battery using, for example, a steel or aluminum outer can. Further, the non-aqueous secondary battery of the present invention may be in the form of a soft package battery using a metal-deposited laminated film as an outer package.

For the positive electrode of the non-aqueous secondary battery, it is possible to use, for example, a positive electrode material mixture layer made from a positive electrode active material, a conductive auxiliary and a binder, and formed on one or both surfaces of a current collector.

For the positive electrode active material, it is possible to use, for example, lithium-containing transition metal oxide expressed as Li₁₊ₓMO₂ (−0.1<x<0.1, M:Co, Ni, Mn and the like); lithium manganese oxide such as LiMn₂O₄; LiMn₍₂₋ₓ₎MₓO₄ which is obtained by substituting a part of Mn of LiMn₂O₄ by another element (0.01<x<0.5, M:Co, Ni, Fe, Mg and the like); olivine-type LiMPO₄ (M:Co, Ni, Mn, Fe); LiMn_{0.5}Ni_{0.5}O₂; and Li₍₁₊ₐ₎MnₓNi_{y}Co_{(1-x-y)}O₂ (−0.1<a<0.1, 0<x<0.5, 0<y<0.5).

For the binder of the positive electrode material mixture layer, for example, polyvinylidene fluoride (PVDF), polytetrafluoroethylene (PTFE), styrene-butadiene rubber (SBR), carboxymethyl cellulose (CMC) and the like are used preferably. Examples of the conductive auxiliary for the positive electrode material mixture layer include: graphites (graphite carbon materials) such as natural graphite (flake-like graphite and the like) and artificial graphite; carbon blacks such as acetylene black,

Ketjen Black, channel black, furnace black, lamp black and thermal black; and carbon materials such as a carbon fiber.

For the current collector of the positive electrode, a current collector similar to what has been used for the positive electrode of a conventionally-known non-aqueous secondary battery can be used, and for example, an aluminum foil 10 to 30 μm in thickness is preferred.

For example, the positive electrode can be produced through the steps of dispersing a positive electrode active material, a binder, and the like in a solvent such as N-methy;-2-pyrrolydone (NMP) so as to prepare a positive electrode material mixture-containing composition in the form of a paste or slurry (the binder may be dissolved in the solvent), applying the positive electrode material mixture-containing composition to one or both surfaces of a current collector, drying the applied composition, and subjecting to a calendering process as needed. The positive electrode is not limited to an electrode produced by any of the method, and they may be produced by any other methods.

The polymer of the present invention can be positioned at a site at which the polymer can be in contact with the positive electrode active material of the non-aqueous secondary battery (more specifically the surface of the positive electrode active material), for example, by e.g. dissolving the polymer in a solvent of the positive electrode material mixture-containing composition so as to prepare a positive electrode material mixture-containing composition that contains also the polymer, and using this composition to form the positive electrode material mixture layer according to the above-described method.

In a case of allowing the polymer to be present on the surface of the positive electrode active material of the non-aqueous secondary battery by the above-described method, from the viewpoint of ensuring more favorably the action of the polymer for the purpose of protecting the positive electrode active material, it is preferable that the amount of the polymer is 0.01 mass parts or more, and more preferably 0.05 mass parts or more with respect to 100 mass parts of the positive electrode active material. However, an excessive amount of the polymer in the non-aqueous secondary battery may increase the cost, thereby causing degradation in productivity of the battery, or causing reduction of the ionic conductivity and an increase in the internal resistance thereby degrading the battery characteristics. Consequently, in a case of allowing the polymer to be present on the surface of the positive electrode active material of the non-aqueous secondary battery, it is preferable that the amount of the polymer is 10 mass parts or less, more preferably 5 mass parts or less with respect to 100 mass parts of the positive electrode active material.

In the positive electrode, a lead connector for electrically connecting to other members within the non-aqueous secondary battery may be formed by a conventional method as needed.

The thickness of the positive electrode material mixture layer formed on each surface of the current collector is preferably 10 to 100 μm, for example. Regarding the compositions of the positive electrode material mixture layer, for example, it is preferable that the amount of the positive electrode active material is 60 to 95 mass %, the amount of the binder is 1 to 15 mass %, and the amount of the conductive auxiliary is 3 to 20 mass %.

For the negative electrode of the non-aqueous secondary battery, a negative electrode constituted by providing on one or both surfaces of a current collector, a negative electrode material mixture layer of a negative electrode material mixture containing a negative electrode active material and a binder and furthermore a conductive auxiliary as needed, or a foil of a negative electrode active material, can be used.

Examples of the negative electrode active material include one type of carbon materials capable of intercalating and deintercalating lithium such as graphite, pyrolytic carbons, cokes, glassy carbons, calcinated organic polymer compounds, mesocarbon microbeads (MCMB), and a carbon fiber or a mixture of two or more types of the carbon materials. Moreover, examples of the negative electrode active material also include the following; simple substances and compounds of elements such as Si, Sn, Ge, Bi, Sb, and In, and their alloys; compounds that can be charged/discharged at a low voltage close to a lithium metal such as a lithium-containing nitride or a lithium-containing oxide; a lithium metal; a lithium/aluminum alloy, and furthermore a Ti oxide expressed by Li₄Ti₅O₁₂.

As the binder and the conductive auxiliary, it is possible to use any of the binders and conductive auxiliaries listed above for use in the positive electrode.

When the negative electrode includes the current collector, the current collector may be, e.g., a foil, a punched metal, a mesh, or an expanded metal, which are made of copper or nickel. In general, a cooper foil is used. If the thickness of the whole negative electrode is reduced to achieve a battery with high energy density, the upper limit for the thickness of the negative electrode current collector is preferably 30 μm. For ensuring the mechanical strength, the lower limit is preferably 5 μm.

For example, the negative electrode can be produced through the steps of dispersing a negative electrode material mixture containing a negative electrode active material, a binder, and, as needed, a conductive auxiliary in a solvent such as NMP or water so as to prepare a negative electrode material mixture-containing composition in the form of a paste or slurry (the binder may be dissolved in the solvent), applying the negative electrode material mixture-containing composition to one or both surfaces of a current collector, drying the applied composition, and subjecting to a calendering process as needed. In a case where the negative electrode active material is the above-described alloys or a lithium metal, the foil can be applied alone or it can be laminated as a negative electrode material layer on the current collector so as to provide a negative electrode. The negative electrode is not limited to an electrode produced by any of these methods, and they may be produced by any other methods.

In the negative electrode, a lead connector for electrically connecting to other members within the lithium secondary battery may be formed by a conventional method as needed.

In a case of a negative electrode having a negative electrode material mixture layer, the thickness of the negative electrode material mixture layer formed on each surface of the current collector is preferably 10 to 100 μm, for example. Regarding the compositions of the negative electrode material mixture layer, for example, it is preferable that the amount of the negative electrode active material is 80.0 to 99.8 mass %, and the amount of the binder is 0.1 to 10 mass %. In a case of adding a conductive auxiliary to the negative electrode material mixture layer, the amount of the conductive auxiliary in the negative electrode material mixture layer is preferably 0.1 to 10 mass %.

The separator of the non-aqueous secondary battery is preferably a porous film formed of a polyolefin such as polyethylene, polypropylene or an ethylene-propylene copolymer, a polyester such as polyethylene terephthalate or copolymerized polyester, or the like. The separator preferably has a property that closes the pores at 100 to 140° C. (or in other words, a shutdown function). Accordingly, it is more preferable that the separator contains, as a component, a thermoplastic resin having a melting point of 100 to 140° C., measured using a differential scanning calorimeter (DSC) in accordance with Japanese Industrial Standard (JIS) K 7121. The separator is preferably a monolayer porous film containing polyethylene as a main component, or a laminated porous film constituted of porous films such as a laminated porous film in which two to five layers made of polyethylene and polypropylene are laminated. In the case of mixing polyethylene with a resin having a melting point higher than that of a polyethylene such as polypropylene, or laminating these, it is desirable to use 30 mass % or more of polyethylene, and more desirably 50 mass % or more, as the resin constituting the porous film.

As such a resin porous film, for example, it is possible to use a porous film made of any of the above-listed thermoplastic resins used in conventionally known non-aqueous secondary batteries and the like, or in other words, an ion permeable porous film produced by a solvent extraction method, a dry or wet drawing method, or the like.

The above-described positive electrode, and the above-described negative electrode can be used in the form of a laminate (laminate electrode assembly) in which the electrodes are laminated with the above-described separator interposed therebetween or a wound electrode assembly obtained by winding the laminate electrode assembly in a spiral fashion, in the non-aqueous secondary battery

As the electrolyte for a non-aqueous secondary battery, a non-aqueous electrolytic solution prepared by dissolving an electrolyte salt in an organic solvent can be used. Examples of the organic solvent include aprotic organic solvents such as propylene carbonate (PC), ethylene carbonate (EC), butylene carbonate (BC), dimethyl carbonate (DMC), diethyl carbonate (DEC), methyl ethyl carbonate (MEC), γ-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric triester, trimethoxymethane, dioxolane derivatives, sulfolane, 3-methyl-2-oxazolidinone, propylene carbonate derivatives, tetrahydrofuran derivatives, diethyl ether and 1,3-propane sultone. These may be used alone or in a combination of two or more. It is also possible to use an aminimide-based organic solvent, a sulfur-containing organic solvent, a fluorine-containing organic solvent, or the like.

As the electrolyte salt used in the non-aqueous electrolytic solution described above, a lithium perchlorate, an organic boron lithium salt, a salt of a fluorine-containing compound such as trifluoromethane sulfonate, an imide salt, or the like is suitably used. Specific examples of the electrolyte salt include LiClO₄, LiPF₆, LiBF₄, LiAsF₆, LiSbF₆, LiCF₃SO₃, LiCF₃CO₂, Li₂CₙF₂ₙ(SO₃)₂ (1≦n≦8), LiN(CF₃SO₂)₂, LiC(CF₃SO₂)₃, LiCₙF₂ₙ₊₁SO₃ (2≦n≦8), LiN(Rf₃OSO₂)₂ where Rf represents a fluoroalkyl group; LiCnF₂ₙ₊₁CO₂ (2≦n≦17), and Li₂CnF₂ₙ(CO₂)₂ (1≦n≦8). These may be used alone or in a combination of two or more. Among them, it is more preferable to use LiPF₆, LiBF₄, or the like because they provide good charge-discharge characteristics. This is because these fluorine-containing organic lithium salts are easily soluble in the above-listed solvents as they have a high anionic character and easily undergo ion separation. There is no particular limitation on the concentration of the electrolyte salt in the non-aqueous electrolytic solution, but the concentration is usually 0.5 to 1.7 mol/L.

For the purpose of improving the battery characteristics such as safety, charge-discharge cycle characteristics and high temperature storage characteristics, an additive such as vinylene carbonates, 1,3-propane sultone, diphenyl disulfide, cyclohexyl benzene, biphenyl, fluorobenzene, or t-butyl benzene can be added to the non-aqueous electrolytic solution as appropriate.

Further, a non-aqueous electrolytic solution that has been gelled by adding a known gelling agent (gel electrolyte) can be used.

In the non-aqueous secondary battery, in order to capture the polymer of the present invention into the non-aqueous electrolytic solution as an electrolyte, it is required simply to dissolve the polymer in the non-aqueous electrolytic solution. In this case, from the viewpoint of exhibiting more favorably the actions provided by use of the polymer (protective action caused by adsorption on the positive electrode active material surface; action of enhancing ionic conductivity of the non-aqueous electrolytic solution), it is preferable that the concentration of the polymer in the non-aqueous electrolytic solution is set to be 0.01 mass % or more, and more preferably, 0.1 mass % or more. However, if the amount of the polymer in the non-aqueous electrolytic solution is excessive, there is apprehension that the viscosity of the non-aqueous electrolytic solution is raised to degrade the ionic conductivity. Therefore, it is preferable that the concentration of the polymer in the non-aqueous electrolytic solution is set to be 20 mass % or less, more preferably, 10 mass % or less, and further preferably 5 mass % or less.

The process of introducing the polymer into the secondary battery of the present invention is not limited to the above-described ones. According to an alternative process, a solution prepared by dissolving the polymer in a solvent is applied to a site within the secondary battery, i.e., a site that may be in contact with the electrolyte (e.g., the inner wall of a casing) and dried for example, so that the coating film of the polymer is formed in advance. In this case, the coating elutes into the electrolyte (non-aqueous electrolytic solution) thereby acting as a component to enhance the ionic conductivity of the electrolyte, and even furthermore adsorbing onto the surface of the positive electrode active material so as to act as a protective agent.

The secondary battery of the present invention can be used for the same applications as those of a conventionally known secondary batteries.

### EXAMPLES

Hereinafter, the present invention will be described in detail by way of examples. It should be noted, however, that the examples given below are not intended to limit the scope of the present invention.

### Example 1

Into a 100 mL three-neck flask having a magnetic stirrer, a hot oil bath, a dripping apparatus, a cooling tube and a nitrogen feeding port, 0.39 g of polyvinyl alcohol (“PVA203” supplied by Kuraray Co., Ltd.) and 20 mL of dimethylacetamide (supplied by Wako Pure Chemical Industries, Ltd.) were introduced, and the oil bath was heated to 100° C. while stirring, thereby dissolving the polyvinyl alcohol. The three-neck flask was taken out from the oil bath and allowed to cool to room temperature. Into the three-neck flask, a solution prepared by mixing 3.1 g of hexafluoroglutaric acid anhydride in 4 mL of pyridine was dripped. After finishing the dripping, stirring was continued for 1 hour. Later, 70 gL of water was added into the three-neck flask and stirred for 20 minutes, to which 0.76 g of lithium hydroxide monohydrate was added further and dissolved, and subsequently an aqueous solution of 1N lithium hydroxide was added to achieve a chemical equivalence.

The thus obtained solution in the three-neck flask was dripped into 300 mL of tetrahydrofuran (supplied by Wako Pure Chemical Industries Ltd.) so as to precipitate. Recovered precipitate was rinsed in tetrahydrofuran, to which 10 mL of ethanol was added subsequently to dissolve the precipitate. In this manner, the precipitation process was repeated. The finally obtained precipitate was dissolved in water and then freeze-dried, thereby providing the polymer of the present invention. The yield was 40%.

The thus obtained polymer has a main chain derived from a polyvinyl alcohol, and it has a pendant group that contains a structural portion where ‘n’ expressed by the General Formula (1) is 3 and M is Li, and has an ester group between the structural portion and the main chain. The amount of the pendant group introduced into the polymer was about 55 mole % with respect to the vinyl alcohol unit constituting the main chain. The number average molecular weight of the polymer was about 50,000.

A positive electrode material mixture-containing composition was prepared by mixing 47 mass parts of nickel-cobalt-lithium manganate (atomic ratio of nickel, cobalt and manganese is 5:2:3) as a positive electrode active material, 1 mass part of carbon as a conductive auxiliary, 2 mass parts of PVDF as a binder, and 0.1 mass parts of the above-described polymer, by using NMP as a solvent. This positive electrode material mixture-containing composition was applied to a surface of an aluminum foil 15 μm in thickness such that a part of the aluminum foil would be exposed, and subjected to drying and calendering processes so as to obtain a positive electrode having a positive electrode material mixture layer about 75 μm in thickness. This positive electrode was punched as a circle 13 mm in diameter, including the exposed part of the current collector.

The above-described positive electrode and the negative electrode prepared by adhering metallic lithium on one surface of a quadrangular stainless steel plate (lithium thickness: 0.5 mm; size: 20×17 mm) were laminated with each other via a separator (which is prepared by laminating a non-woven fabric and a porous film of PE 18 μm in thickness) and inserted into a casing. Into the casing, a non-aqueous electrolytic solution (a solution prepared by dissolving LiPF₆ in a concentration of 1 mol/L in a solvent as a mixture of ethylene carbonate and diethyl carbonate at a volume ratio of 3:7) was also injected. Subsequently, the casing was sealed to produce a non-aqueous secondary battery (lithium ion secondary battery).

### Comparative Example 1

A positive electrode was produced similarly to Example 1, using a positive electrode material mixture-containing composition prepared similarly to Example 1 except that the polymer was not added. A non-aqueous secondary battery was prepared similarly to Example 1 except that this positive electrode was used.

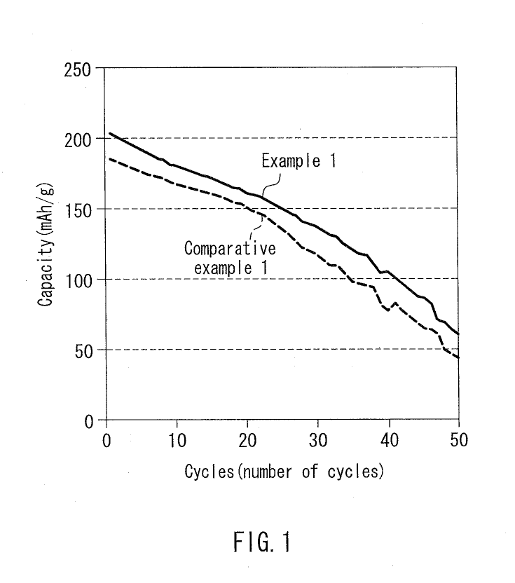

Regarding the non-aqueous secondary batteries of Example 1 and Comparative example 1, the charge-discharge cycle characteristics were evaluated in the following manner. The respective batteries were charged at a current of 8 mA until the voltage reached 4.7 V. Further, a constant-current constant-voltage charge of charging at a constant voltage of 4.7 V was performed (total charge time is 5 hours), which was followed by a discharge at a current of 8 mA until the voltage reached 2.5 V. The series of operations were set as one cycle. This cycle was repeated 50 times, and the discharged capacity for every cycle number was measured. The results are shown in FIG. 1.

The non-aqueous secondary battery of Example 1 is produced by using a positive electrode material mixture-containing composition that contains the polymer. As evidently shown in FIG. 1, the non-aqueous secondary battery of Example 1 having a positive electrode including the polymer present on the surface of the positive electrode active material has a higher capacity at the evaluation of the charge-discharge cycle characteristics in comparison with the battery of Comparative example 1 that does not use the polymer. The reason for this seems to be as follows. The polymer that has an excellent ion dissociation in a solvent for a non-aqueous electrolytic solution (organic solvent) and an excellent oxidation resistance protects the positive electrode active material without inhibiting insertion and desorption of ions, and this serves to suppress favorably decomposition and degradation of the non-aqueous electrolytic solution component caused by the reaction between the positive electrode and the non-aqueous electrolytic solution.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A polymer comprising:
a plurality of pendant groups,
wherein each of the pendant groups comprises a carboxyl group or salt thereof, and a group interposed between a main chain and the carboxyl group or salt thereof,
wherein the group interposed between the main chain and the carboxyl group or salt thereof is a hydrocarbon group, a perfluorocarbon group, a combination of a hydrocarbon group and at least one of an ester group and a carbonate group, or a combination of a perfluorocarbon group and at least one of an ester group and a carbonate group,
wherein a carbonyl carbon included in the carboxyl group or salt thereof is bonded directly to a carbon included in either the hydrocarbon group or the perfluorocarbon group, and
wherein in a case where the group interposed between the main chain and the carboxyl group or salt thereof is the hydrocarbon group or the combination of the hydrocarbon group and the at least one of the ester group and the carbonate group, fluorine is bonded to at least a carbon among the carbons included in the hydrocarbon group located at an α-position or a β-position of the carbonyl carbon included in the carboxyl group or salt thereof.

2. The polymer according to claim 1, wherein the pendant group comprises a structural portion expressed by General Formula (1) below: 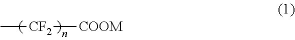
wherein in General Formula (1) above, n is an integer from 1 to 20, and M denotes hydrogen, a metal or ammonium.

3. The polymer according to claim 1, wherein the main chain comprises a hydrocarbon group, a perfluorocarbon group, a hydrocarbon group and at least one of an ester group and a carbonate group, or a perfluorocarbon group and at least one of an ester group and a carbonate group.

4. The polymer according to claim 1, wherein the polymer is adapted for use in a secondary battery.

5. A secondary battery, comprising:
a positive electrode containing
a positive electrode active material,
a negative electrode,
a separator and
an electrolyte,
wherein the secondary battery contains the polymer according to claim 1.

6. The secondary battery according to claim 5, wherein the polymer is positioned at a site to be in contact with either the electrolyte or the positive electrode active material, or the polymer is captured in the electrolyte.

7. The secondary battery according to claim 5, wherein the polymer is present on the surface of the positive electrode active material.

8. The secondary battery according to claim 5, wherein the electrolyte is a non-aqueous electrolytic solution.
